(19) United States
(12) Patent Application Publication
(10) Pub. No.: US 2025/0272680 A1
(43) Pub. Date: Aug. 28, 2025

(54) FEDERATED TRUST USING THIRD PARTY

(71) Applicant: Wells Fargo Bank, N.A., San Francisco, CA (US)

(72) Inventors: Suzanne M. Fisi, Clayton, CA (US); Gavin Fung, Oakland, CA (US); Weston Thackeray Thompson, Claremont, CA (US); Ravi Kanth Thota, San Francisco, CA (US)

(21) Appl. No.: 18/585,949

(22) Filed: Feb. 23, 2024

(51) Int. Cl. G06Q 20/40; G06Q 20/10; G06Q 20/36

(52) U.S. Cl. CPC G06Q 20/40; G06Q 20/10; G06Q 20/36

(57) ABSTRACT

Systems and techniques may generally be used to authenticate users. An example technique may include receiving a selection to execute a first financial transaction on a first user account of a first user at a financial institution, the first financial transaction having an authentication level requirement, and determining that the first user completed a selected authentication option that satisfies the authentication level requirement. The example technique may include, in response to the determination, authorizing the first financial transaction to execute using the first user account.

### BACKGROUND

Online services serve many purposes. For example, a user may access online services to connect with a financial institution and transfer money, see their account balances, or the like. To complete an online transaction, the user may need to be authenticated by an online service. User authentication in an online service may be difficult for certain users (e.g., users without a mobile device). As a result, some users are unable to complete transactions on online services.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram of elements of a user computing device and a financial institution server according to various examples.

FIG. 2 is a diagram representing a user authentication process according to various examples.

FIG. 3 is a diagram representing a user authentication process through two or more user authentications according to various examples.

FIG. 4 is a diagram representing a user authentication process using user authentications via third-party entities according to various examples.

FIG. 5 is a flowchart illustrating a method for user authentication in accordance with various examples.

FIG. 6 is a flowchart illustrating a method for user authentication via third-party entities in accordance with various examples.

FIG. 7 is a block diagram illustrating a machine in the example form of a computer system, within which a set or sequence of instructions may be executed to cause the machine to perform any one or more of the techniques discussed herein, according to various examples.

### DETAILED DESCRIPTION

Throughout this disclosure, components may take electronic actions in response to different variable values (e.g., thresholds, user preferences, or the like). As a matter of convenience, this disclosure does not always detail where the variables are stored or how they are retrieved. In such instances, it may be assumed that the variables are stored on a storage device (e.g., RAM, cache, hard drive) accessible by the component via an API or other program communication method. Similarly, the variables may be assumed to have default values should a specific value not be described. User interfaces may be provided for an end-user or administrator to edit the variable values in some instances.

In various examples described herein, user interfaces are described as being presented to a computing device. The presentation may include transmitting data (e.g., a hypertext markup language file) from a first device (such as a web server) to the computing device for rendering on a display device of the computing device via a rendering engine such as a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although, in some examples, these portions may be displayed on a screen simultaneously, in other examples, the portions/elements may be displayed on separate screens such that not all portions/elements are displayed simultaneously. Unless indicated as such, the use of “presenting a user interface” does not infer either one of these options.

Additionally, the elements and portions are sometimes described as being configured for a particular purpose. For example, an input element may be described as configured to receive an input string. In this context, “configured to” may mean presenting a user interface element that can receive user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search method that formats and executes a structured query language (SQL) query to a database.

A user may have an account with a company but still not be able to be authenticated to complete a transaction via the company. For example, a user may have an account with a financial institution, which may require additional authentication to complete a transaction with the account. The user may need to complete a separate authentication process to complete the transaction at the financial institution. In some examples, access to a mobile device may present an authentication challenge. For example, the authentication process may include typing a one-time password/passcode (OTP) code received on a mobile phone.

Accordingly, described herein are improvements to authentication systems that authenticate a user, for example, by another user's device, a third party device, actions undertaken via a third-party entity, or the like.

A user may initiate an online transaction, for example, to be completed using a user account at a financial institution. After receiving a transaction request, a server of the financial institution may determine that the user is not authenticated to complete the transaction. Based on the determination, the server may prompt an authentication process for the user.

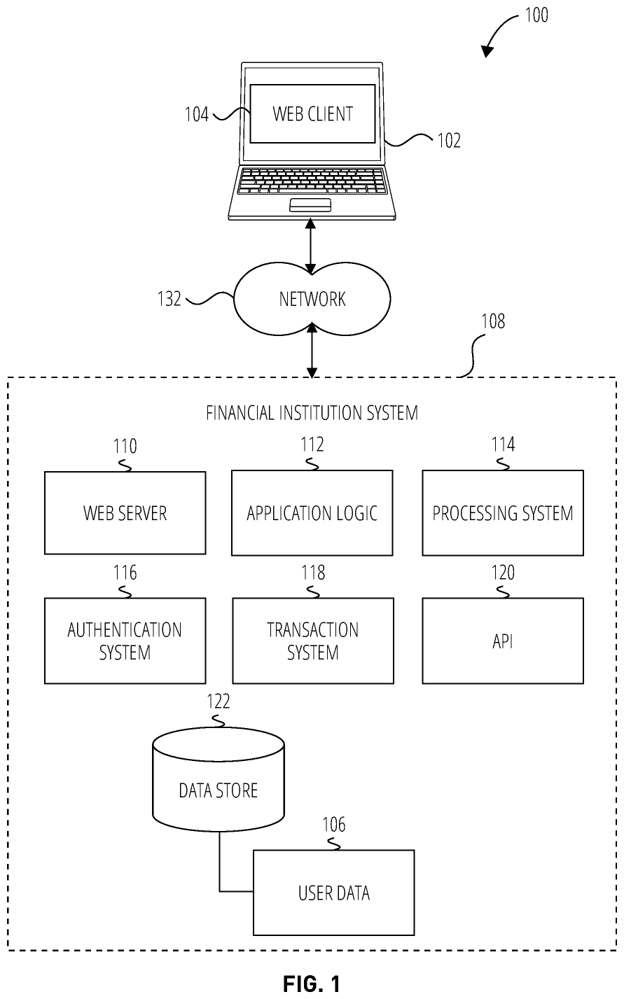

FIG. 1 is a schematic diagram 100 of a computing device 102 and a financial institution system 108, according to various examples. In FIG. 1, the financial institution system 108 includes a web server 110, application logic 112, a processing system 114, an authentication system 116, a transaction system 118, user data 106, an application programming interface (API) 120, and a data store 122.

The financial institution system 108 is illustrated as a set of separate components. However, the functionality of multiple individual components may be performed by a single component or a combination of components. A component may represent circuitry, such as computer program code or hardware circuitry that is executable by processing system 114. The program code may be stored on a storage device (e.g., data store 122) and loaded into a memory of the processing system 114 for execution. Portions of the program code may be executed in a parallel across multiple processing units. A processing unit may include a core of a general purpose computer processor, a graphical processing unit, an application specific integrated circuit, a tensor processing core operating a single device or multiple devices, or the like. Accordingly, execution of the code using a processing unit may be performed on a single device or distributed across multiple devices.

The computing device 102 may include a mobile device (e.g., a smartphone, a tablet, or the like), a laptop, a multi-processor system, a microprocessor-based or programmable consumer electronic device, a game console, a set-top box, or other device that a user utilizes to communicate over a network. In various examples, a computing device includes a display to display information (e.g., in the form of a specially configured user interface). In some embodiments, computing devices may include one or more of a touch screen, camera, keyboard, microphone, or Global Positioning System (GPS) device.

The computing device 102 and the financial institution system 108 may communicate via a network 132. The network 132 may include local-area networks (LAN), wide-area networks (WAN), wireless networks (e.g., 802.11 or cellular network), the Public Switched Telephone Network (PSTN) Network, ad hoc networks, cellular, personal area networks, or peer-to-peer (e.g., Bluetooth®, Wi-Fi Direct), or other combinations or permutations of network protocols and network types.

The financial institution system 108 may include a web server 110 to enable data exchanges with the computing device 102 via a web client 104. Although generally discussed in the context of delivering webpages via the Hypertext Transfer Protocol Secure (HTTPS), other network protocols may be utilized by web server 110 (e.g., File Transfer Protocol, Telnet, Secure Shell, or the like). A user may enter a uniform resource identifier (URI) into web client 104 (e.g., Firefox browser from Mozilla, SAFARI® web browser by Apple Inc., or the like) that corresponds to the logical location (e.g., an Internet Protocol address) of web server 110. In response, web server 110 may transmit a web page that is rendered on a display device of a client device (e.g., a mobile phone, desktop computer, or the like).

Additionally, the web server 110 may enable a user to interact with one or more web applications provided on a transmitted web page or via a downloaded application. A web application may provide user interface (UI) components that are rendered on a display device of the computing device 102. The user may interact (e.g., select, move, enter text into) with the UI components and, based on the interaction, the web application may update one or more portions of the web page. A web application may be executed in whole, or in part, locally on the computing device 102. The web application may populate the UI components with data from external sources or internal sources (e.g., data store 122) in various examples.

In various examples, the web application provides user interfaces and functionality for accessing online services and completing financial transactions (e.g., transferring money, paying a bill, or the like). The web application may be executed according to application logic 112. Application logic 112 may use the various elements of financial institution system 108 to implement the web application. For example, application logic 112 may issue API calls to retrieve or store data from data store 122 and transmit it for display on computing device 102. Similarly, data entered by a user into a UI component may be transmitted using API 120 to the web server 110. Application logic 112 may use other elements (e.g., Authentication system 116, transaction system 118, or the like) of financial institution system 108 to perform functionality associated with the web application as described further herein.

Data store 122 may store data that is used by financial institution system 108. Data store 122 is depicted as a singular element but may be multiple data stores. The specific storage layout and model used by data store 122 may take several forms—indeed, a data store 122 may utilize multiple models. Data store 122 may be, but is not limited to, a relational database (e.g., SQL), a non-relational database (NoSQL), a flat-file database, an object model, a document details model, a graph database, a distributed ledger (e.g., blockchain), or a file system hierarchy. Data store 122 may store data on one or more storage devices (e.g., a hard disk, random access memory (RAM), or the like). The storage devices may be in standalone arrays, part of one or more servers, and located in one or more geographic areas.

Data structures in data store 122 may be implemented in several manners depending on the programming language of an application or database management system used by an application. For example, if C++ is used, the data structure may be implemented as a struct or class. In the context of a relational database, a data structure may be defined in a schema.

User data 106 may store data associated with customers of a business (such as clients of a financial institution). For example, user data 106 may be stored in a database (e.g., data store 122) with a user profile table and a user account table. A user profile may be generated and stored in the user profile table.

User data 106 may include user profiles of users of the financial institution system 108. A user profile may include credential information such as a username and hash of a password. A user may enter their username and plaintext password to a login page of the financial institution system 108 to view their user profile information or interfaces presented by the financial institution system 108 in various examples.

An authentication level requirement may be stored in the user profile (discussed further below with authentication system 116). For example, the authentication level requirement may include a first user being authenticated by a second user device, a third party device, an action taken with a third-party entity, or the like.

In various examples, a first user account of a first user may be linked to a second user account of a second user by adding the second user account information to a first user profile of the first user. In several examples, adding the second user account information to the first user profile may include registering a computing device of the second user. In other examples, the first user account may be linked to the second user account of the second user by adding the first user account information to the second user profile of the second user.

Linking the first user account to the second user account may authorize the authentication of the first user by the second user. For example, the second user may receive an authentication request and authenticate the first user. The authentication request may be a link sent via e-mail, SMS, a push notification, or the like. The second user may receive the authentication request as a push notification on an application used to access the second user account. The application may be installed on the computing device of the second user. In various examples, the second user may authenticate the first user by sending an authentication confirmation through the application used to access the second user account. In other examples, a confirmation code (e.g., a PIN, OTP, or the like) may be sent to the computing device of the second user and typed into the computing device of the first user to authenticate the first user. The second user may enter a PIN code, use a swipe gesture, enter a biometric recognition parameter (e.g., voice, face, fingerprint, etc.), or the like to their computing device in order to authenticate the first user.

A user profile may identify a computing device associated with the user. For example, a user may register one or more phones, desktop computers, tablets, or laptops with financial institution system 108. The computing device may be owned by another user or a third party. Registering may include authorizing the financial institution system 108 to send authentication requests to these devices. A user may revoke authorization to authenticate the user using any of those registered devices by updating their user profile.

A user profile may also include authorization to access other services at a third party entity in which the user has an account (e.g., a store account, another financial institution account, or the like). The authorizations may include a token (e.g., using OAuth) or login credentials that authorize financial institution system 108 to retrieve data from the other services in a defined format such as JavaScript Object Notation (JSON) or extensible markup language (XML) over an API. A reciprocal authorization may also be stored in the user profile that authorizes the other services to access data stored in the user profile. A user profile may be associated with one or more accounts of a user. The authorization to access other services in which the user has an account allows the financial institution system 108 via the authentication system 116 to authenticate the user at the third party entity (e.g., the user logging into an account at the third-party entity, the user completing a transaction at the third party entity, or the like).

The authentication system 116 may track the authentication level requirement of a transaction (e.g., none, low, medium, high, one or more specific requirements, or the like). The authentication level may correspond to a degree of confidence in the identity of the user. For example, a user logging into an online service with a username and password without two-factor authentication (2FA) may have a lower level of trust than a user logging in with 2FA. The authentication system 116 may associate authentication level requirements to an authentication level. After receiving an authentication confirmation, the authentication system 116 may determine whether the authentication level requirement was met for a transaction based on the authentication used.

The level of authentication may be dynamic. For example, when a user attempts to complete an unexpected transaction based on a prior behavioral profile (e.g., transferring a large sum of money overseas), the authentication level requirement may be raised. Raising the authentication level may include increasing the authentication requirement relative level (e.g., from none to low, from low to medium, from medium to high, from low to high, or the like), adding a specific requirement or set of requirements (e.g., two-factor required), or the like. Similarly, an expected transaction (e.g., a daily purchase of coffee) may have a low authentication level requirement. The transaction system 118 may be configured to authorize or deny a user attempt to complete a transaction on the user account.

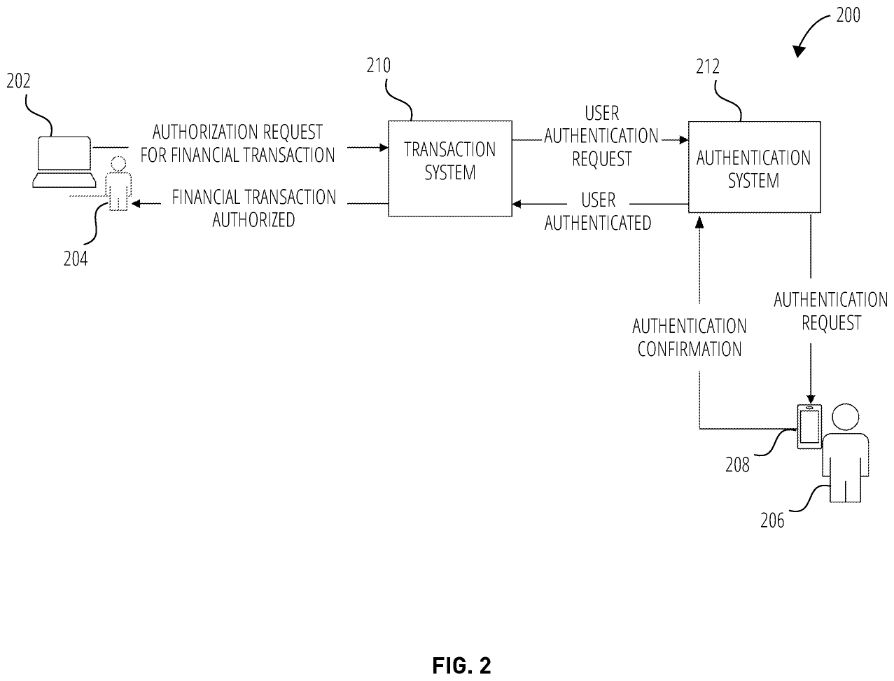

FIG. 2 is a diagram representing a user authentication process 200 according to various examples. The diagram includes a user 204 and a computing device 202. The computing device 202 may be used to access a user account of the user 204, for example, a user account of a financial institution. The user account may be used to complete a financial transaction by sending an authorization request to a transaction system 210. The transaction system 210 may transmit user data to an authentication system 212. The user data may include data associated with customers of a business (such as clients of a financial institution). For example, the user data may be stored in a database. The user data may include a user profile table or a user account table. A user profile may be generated and stored in the user profile table, for example, by the authentication system 212. In various examples, the user profile includes one or more user authentication requirements for the user account to be authenticated.

The authentication system 212 may determine an authentication level requirement for the transaction, for example, based on a type of the transaction. The authentication level requirement may include a relative level (e.g., none, low, medium, high) or a specific requirement or set of requirements (e.g., two-factor required). For example, the authentication system 212 may query a data store to determine a current level of authentication for the user 204 or the computing device 202. The current level of authentication (e.g., the user is logged in via password) may be compared to the authentication level requirement (e.g., biometric required) for the requested transaction. In this example, because the user 204 is logged in via password only and the authentication level requirement needs a biometric confirmation, the user 204 may be asked (e.g., via the computing device 202) to provide biometric identification to complete the transaction. The authentication level requirement may include using two or more user authentications. In some examples, the authentication system 212 may determine the authentication level requirement dynamically based on a prior behavioral profile (e.g., an unexpected transaction based on previous transactions completed by the user 204).

FIG. 2 illustrates an example of user authentication where the authentication system 212 sends an authentication request to a computing device 208 of a second user 206 to authenticate the user 204. In some examples, the second user 206 is a client of the financial institution having at least one user account. The second user 206 may authenticate the user 204 using a user account of the second user 206 at the financial institution. In other examples, the second user 206 is a third party without a user account at the financial institution. The user 206 may authenticate the user 204 using a contact information of user 206. For example, the user 204 may be authenticated by typing a one-time confirmation code sent to the contact information of the third party, replying to a message sent to the contact information of the third party requesting to confirm authentication of the first user, clicking on a link included in a message sent to the contact information of the third party to confirm authentication of the first user, pressing a key as requested in a call to the contact information of the third party to confirm authentication of the first user, or the like. The second user 206 may be registered as a trusted person at the financial institution (with or without an account at the financial institution). The authentication request may be sent to the computing device 208 to satisfy an authentication level requirement, in some examples, although it may be sent as an authentication technique without an authentication level requirement in other examples.

In various examples, the authentication request includes a link sent via e-mail, SMS, a push notification, or the like. The authentication request may be sent to the computing device 208 as a push notification via an application installed on the computing device 208. The push notification may be used to access a user account of the second user 206. The push notification may prompt the second user 206 to confirm or deny the identity of the user 204. In response to receiving confirmation of the identity of the user 204, the computing device 208 may automatically send an authentication confirmation to the authentication system 212. In some examples, instead of or in addition to the push notification, a link may be emailed to the second user 206, a call may be made to a device (e.g., the computing device 208) of the second user 206, a text (e.g., SMS) or other message may be sent to the computing device 208, or the like.

After receiving the authentication confirmation, the authentication system 212 may send a confirmation code (e.g., a PIN, OTP, or the like) to the computing device 208 or the computing device 202. In the example where the confirmation code is sent to the computing device 208, the user 204 may type or otherwise transfer (e.g., via NFC) the confirmation code into the computing device 202 to authenticate the first user.

The second user 206 may confirm or deny the authentication of the user 204. When the second user 206 denies authentication of the user 204, the authentication system 212 may send a message to the transaction system 210 indicating that the user 204 was not authenticated or indicating that the transaction is to be held or canceled. In response to receiving the message from the authentication system 212, the transaction system 210 may hold or cancel the transaction. The second user may authenticate the first user via a PIN code, a swipe gesture, a biometric parameter, or the like.

In some examples, the computing device 208 sends an authentication confirmation to the authentication system 212 in response to the second user 206 authenticating the user 204. In response to receiving the authentication confirmation, the authentication system 212 may send an indication to the transaction system 210 that the user 204 is authenticated. In some examples, in response to receiving the authentication confirmation, the authentication system 212 may determine whether the authentication level requirement of the transaction was met based on the user authentication used. When the authentication confirmation (or other authentication of the user 204) meets the authentication level requirement, the authentication system 212 may send a message to the transaction system 210 confirming the user authentication. The transaction system 210 may authorize the user 204 to complete the transaction or authorize the transaction to be completed (e.g., transfer money, use a credit card, use a debit card, or the like) in response to receiving the confirmation.

In response to determining that the authentication level requirement was not met, the authentication system 212 may send an indication to the computing device 202 or the computing device 208 requiring further authentication, or the authentication system 212 may send an indication to the transaction system 210 that the authentication level requirement was not met.

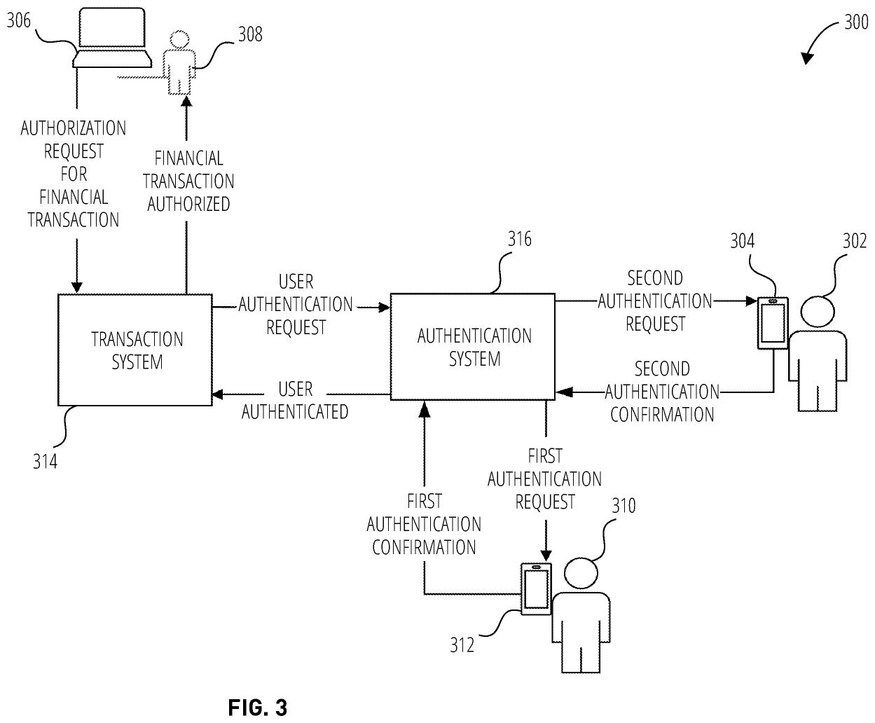

FIG. 3 is a diagram representing a user authentication process 300 according to various examples. The diagram shows a user authentication process where after receiving a first authentication confirmation, the authentication system 316 determines that the authentication level requirement of the transaction was not met.

A user may be authenticated via a third party. The third party, illustrated here as person 302 or device 304, does not need to be a client or have an account at a financial institution attempting to authenticate the user 308. Instead, the third party 302 may be registered at the financial institution, for example, by the user 308 indicating that the third party 302 is to be contacted for authentication of the user 308. Registering the third party may include registering the contact information of the third party 302 to the user profile of the user 308 to authorize the third party 302 to authenticate user 308. In some examples, adding the contact information (e.g., a phone number, a device identifier of the device 304, an e-mail, or the like) of the third party 302 to the user profile of user 308 includes registering the third party 302 at the financial institution as a trusted person (e.g., registering the credentials of the third party 302 at the financial institution).

In response to determining that the authentication level requirement was not met (e.g., failed to authenticate by the second user 310, the authentication level requirement indicates that a second form of authentication is necessary, or the like), the authentication system 316 may attempt another authentication of the user 308. The authentication system 316 may, for example, send an authentication request to the device 304 of the third party 302. The authentication system 316 may send an authentication request via the registered contact information of the third party 302.

The authentication request may include sending a one-time confirmation code to the contact information of the third party 302 to be entered on the computing device 306 to confirm authentication of the user 308. The authentication request may include sending an indication via the contact information of the third party 302 requesting a reply to the indication confirming the authentication of user 308. The authentication request may include a link sent to the device 304, the link accessible to confirm the authentication of the user 308. The authentication request may include a call to the device 304. The authentication request may include a request sent to the device 304 asking the third party 302 to enter a confirmation code (e.g., a PIN, a swipe gesture, a biometric recognition parameter, or the like). The authentication request may include a request to tap a card (e.g., credit card, debit card, or the like) on the device 304. The authentication request may include a push notification sent to the device 304. The user 308 may be authenticated using an application installed on the device 304.

After receiving the second authentication request, the third party 302 may confirm or deny authentication of the user 308. When the third party 302 denies authentication of the user 308, the authentication system 316 may send a message to the transaction system 314 indicating that the user 308 was not authenticated. In response to the message, the transaction system 314 may cancel or hold the transaction.

After receiving an authentication confirmation of the user 308 from the computing device 304, the authentication system 316 may authenticate the user 308 to the transaction system 314. In some examples, the authentication system 316 may determine whether an authentication level requirement of the transaction was met. When the authentication level requirement is met, the authentication system 316 may send a message to the transaction system 314 confirming the user authentication or indicating that the transaction is to proceed. In response to receiving the confirmation, the transaction system 314 may authorize the user 308 to complete the transaction or authorize the transaction to be completed (e.g., transfer money, use a credit card, use a debit card, or the like).

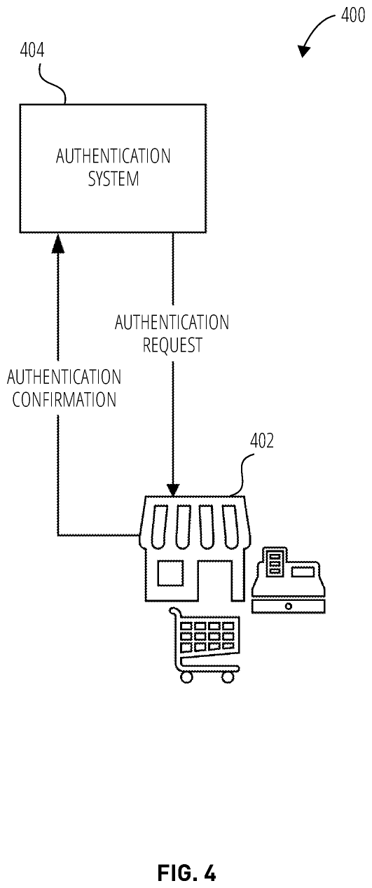

FIG. 4 is a diagram representing a method of user authentication 400 via a third-party entity 402. A user may choose to authenticate via a third-party entity in order to execute or complete a transaction at a financial institution (e.g., transferring money, using a debit card or credit card at a third-party entity, or the like). The third-party entity 402 may include an online store, a physical store (e.g., a grocery store, a retail store, a warehouse store, or the like), a residential facility, a care facility, an education institution, a hospital, another financial institution, a digital payment network, a digital wallet, or the like. The user may be authenticated by indicating that an additional transaction will occur with a particular third party entity 402. For example, the user may indicate (e.g., to an entity facilitating the transaction) that a second financial transaction will be completed at the third-party entity 402. The second financial transaction may include a future routine transaction that is verifiable as similar to a previous transaction (e.g., a grocery store purchase of an amount similar to a previous purchase, coffee at a regular coffee shop, or the like). In some examples, the second financial transaction may be specified by one or more parameters (e.g., more parameters being correlated to increased security), such as location (e.g., physical store or website), amount, time of transaction, counterparty, a method of payment (e.g., credit card, debit card, etc.), or the like. In other examples, a second transaction may be a non-financial transaction, such as logging into an account at the third-party entity 402.

In some examples, the user may be verified at the third-party entity 402 such as by presenting a debit card, a credit card, a government ID, entering a PIN, entering an OTP, or the like. In the examples using a debit card or a credit card, they may be associated with the financial institution corresponding to the transaction. The second financial transaction may include a money transfer from an account of the user at the third party entity 402 to an account specified by the financial institution corresponding to the transaction. The account specified by the financial institution may be an account at the financial institution, such as another account of the user, an account of a registered second user, a general account, or the like. The money transfer may be of a nominal value (e.g., a penny, a dime, or the like) or of a specified value.

The authentication system 404 may receive an indication from the third party entity 402 in some examples, such as when the third party entity 402 has agreed to authenticate the user. In other examples, the authentication system 404 may determine that the user has completed the second financial transaction at the third party entity 402, and authenticate the user based on that determination (e.g., without direct knowledge or involvement in the authentication determination by the third party entity 402). After authenticating the user via the third-party entity 402, the authentication system 404 may determine whether the authentication level requirement of the transaction was met, for example, as described above.

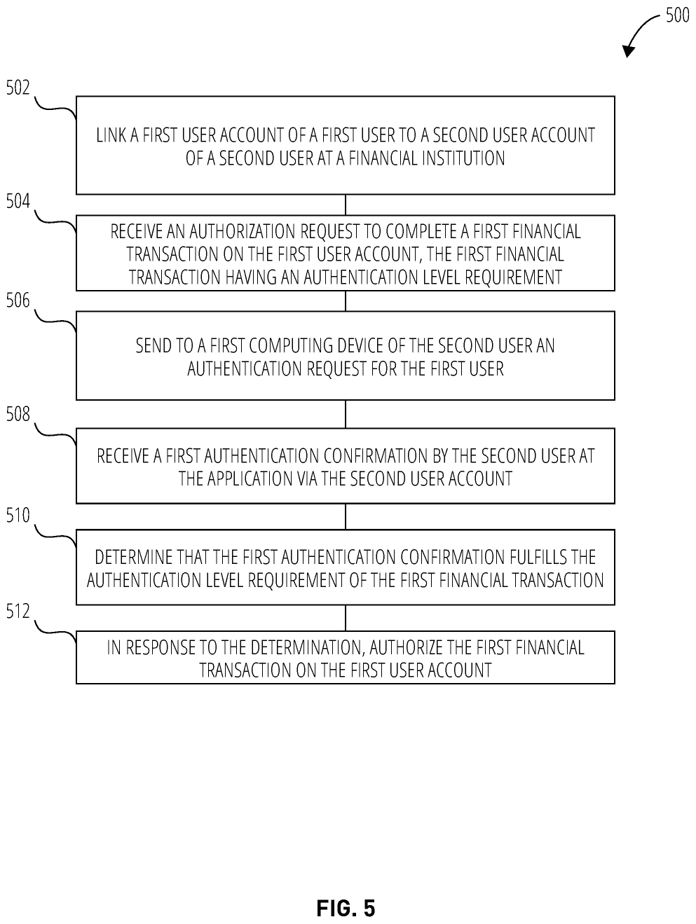

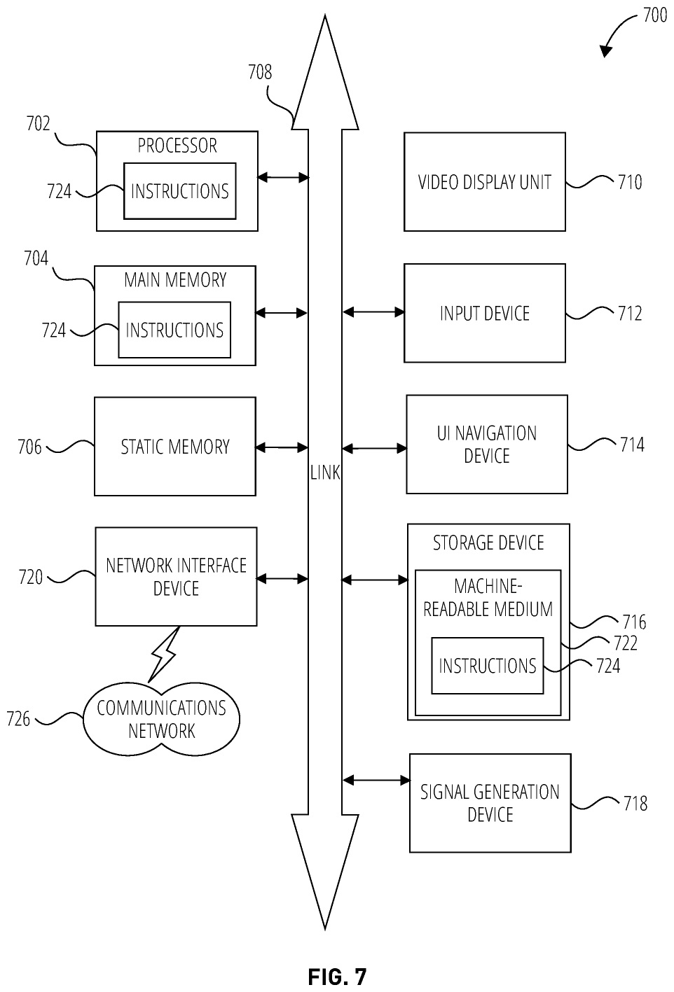

FIG. 5 is a flowchart illustrating a technique 500, according to various examples. In an example, operations of the technique 500 may be performed by processing circuitry, for example, by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 7.

The technique 500 includes an operation 502 to link, for example using processing circuitry, a first user account of a first user to a second user account of a second user, for example, at a financial institution. In some examples, the linking includes authorizing the first user to be authenticated by a first computing device of the second user. The first user account of the first user may be linked to the second user account of the second user by adding the second user account information to a first user profile of the first user. Adding the second user account information to the first user profile may include registering a computing device of the second user. In some examples, the first user account may be linked to the second user account of the second user by adding the first user account information to a second user profile of the second user. In some examples, the first user account may be linked to a third party by adding a contact information of the third party to the first profile of the first user. Adding the contact information of the third party to the first profile may include registering the third party at the financial institution. The linking of the first user account to the third party may authorize the third party to authenticate the first user.

The technique 500 includes an operation 504 to receive an authorization request to complete a first financial transaction on the first user account, the first financial transaction having an authentication level requirement. The first financial transaction may include a money transfer, a money request, a debit card transaction, a credit card transaction, or the like.

The technique 500 includes an operation 506 to send to the first computing device of the second user an authentication request for the first user. In some examples, the authentication request includes a push notification to an application used to access the second user account on the first computing device of the second user. The application may include a web application provided on a transmitted web page or an application downloaded at an application store.

In some examples, an authentication request may be sent to a computing device of the first user. The first user may send an indication to be authenticated by a third party. In response to receiving the indication, an authentication confirmation check may be sent to the contact information of the third party added to the first profile. The authentication confirmation check may include a request to type a one-time confirmation code sent to the contact information of the third party on the second computing device of the first user, to reply to a message sent to the contact information of the third party, to click on a link included in a message sent to the contact information of the third party, to press a key as requested in a call to the contact information of the third party, or the like.

The technique 500 includes an operation 508 to receive, for example, using processing circuitry, a first authentication confirmation from the second user at the application via the second user account. The first authentication confirmation may indicate that the first user was authenticated by the second user. In examples where the third party authenticates the first user, the technique 500 may include an operation to receive a second authentication confirmation from the third party. The second authentication confirmation may indicate that the first user was authenticated by the third party.

The technique 500 includes an operation 510 to determine that the first authentication confirmation meets the authentication level requirement of the first financial transaction.

In some examples, technique 500 may include an operation to determine that a third authentication confirmation does not meet a third authentication level requirement of a third financial transaction. In response to the determination, a fourth authentication request may be sent to a computing device of a third party. The third party may send a fourth authentication confirmation. The fourth authentication confirmation may include, for example, information indicative of a tapped credit card on the computing device of the third party, an entered confirmation code (e.g., a PIN, a swipe gesture, or a biometric recognition parameter) on the computing device of the third party, a confirmed authentication on an application on the computing device of the third party, or the like.

The technique 500 includes an operation 512 to, in response to the determination, authorize the first financial transaction on the first user account.

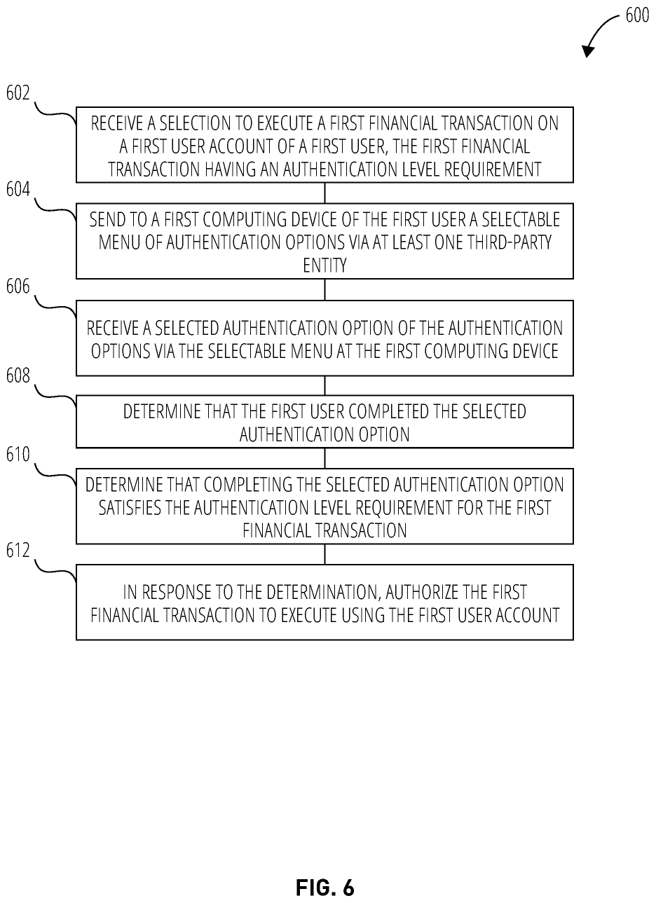

FIG. 6 is a flowchart illustrating a technique 600, according to various examples. In an example, operations of the technique 600 may be performed by processing circuitry, for example by executing instructions stored in memory. The processing circuitry may include a processor, a system on a chip, or other circuitry (e.g., wiring). For example, technique 600 may be performed by processing circuitry of a device (or one or more hardware or software components thereof), such as those illustrated and described with reference to FIG. 7.

The technique 600 includes an operation 602 to receive a selection to execute a first financial transaction on a first user account of a first user, the first financial transaction having an authentication level requirement.

The technique 600 includes an operation 604 to send to a first computing device of the first user a selectable menu of authentication options via at least one third-party entity. The third-party entity may include an online store, a physical store, a grocery store, a retail store, a warehouse store, a residential facility, a care facility, an education institution, a hospital, a financial institution, a digital payment network, a digital wallet, or the like.

The user may, for example, be authenticated via a third-party entity by completing a second transaction at the third-party entity. The second transaction may include a financial transaction, logging into an account at the third-party entity, the third-party entity verifying the identity of the first user (e.g., verifying a government ID, a credit card, a debit card, etc.), or the like.

The technique 600 includes an operation 606 to receive a selected authentication option of the authentication options via the selectable menu at the first computing device. The selected authentication option may include, for example, completing a transaction at a third-party entity, a verification at the third-party entity of the identity of the first user, a validation using a debit card, a validation using a credit card, or the like. In examples using the debit card and the credit card, a card may be associated with the financial institution corresponding to the transaction. In some examples, the selected authentication option may include completing a transfer from an account of the first user at the third-party entity to an account specified by the financial institution. In other examples, the selected authentication option may include completing a transfer from an account of the first user at the third-party entity to an account registered on the first user account at the financial institution.

The technique 600 includes an operation 608 to determine that the first user completed the selected authentication option. In some examples, determining that the first user completed the selected authentication option includes receiving an authentication confirmation from the third-party entity.

The technique 600 includes an operation 610 to determine that completing the selected authentication option satisfies the authentication level requirement for the first financial transaction.

The technique 600 includes an operation 612 to, in response to the determination, authorize the first user to execute the first financial transaction using the first user account.

FIG. 7 is a block diagram illustrating a machine in the example form of computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, or the like), a main memory 704, and a static memory 706, which communicate with each other via a link 708. The computer system 700 may further include a video display unit 710, an input device 712 (e.g., a keyboard), and a user interface UI navigation device 714 (e.g., a mouse). In one embodiment, the video display unit 710, input device 712, and UI navigation device 714 are incorporated into a single device housing such as a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, or other sensors.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, the static memory 706, and/or within the processor 702 during execution thereof by the computer system 700, with the main memory 704, the static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 722 that excluded transitory signals.

The instructions 724 may further be transmitted or received over a communications network 726 using a transmission medium via the network interface device 720 utilizing any one of a number of well-known transfer protocols (e.g., HTTP). Examples of communication networks include a Local Area Network (LAN), a Wide Area Network (WAN), the Internet, mobile telephone networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Example 1 is a method for user authentication, the method comprising: linking, using processing circuitry, a first user account of a first user to a second user account of a second user at a financial institution, the linking authorizing the first user to be authenticated by a first computing device of the second user; receiving an authorization request to complete a first financial transaction on the first user account, the first financial transaction having an authentication level requirement; sending to the first computing device of the second user an authentication request for the first user, the authentication request including a push notification to an application used to access the second user account on the first computing device of the second user; receiving, using the processing circuitry, a first authentication confirmation from the second user at the application via the second user account; determining that the first authentication confirmation meets the authentication level requirement of the first financial transaction; and in response to the determination, authorizing the first financial transaction on the first user account.

In Example 2, the subject matter of Example 1 includes, wherein linking the first user account to the second user account includes at least one of adding the second user account to a first profile of the first user, or adding the first user account to a second profile of the second user.

In Example 3, the subject matter of Examples 1-2 includes, adding a contact information of a third party to a first profile of the first user; receiving a second authorization request to complete a second financial transaction on the first user account, the second financial transaction having a second authentication level requirement; sending to a second computing device of the first user a second authentication request for the first user; in response to receiving an indication from the first user, sending an authentication confirmation check to the contact information of the third party; receiving, using the processing circuitry, a second authentication confirmation; determining that the second authentication confirmation meets the second authentication level requirement of the second financial transaction; and in response to the determination, authorizing the second financial transaction on the first user account.

In Example 4, the subject matter of Example 3 includes, wherein adding the contact information of the third party to the first profile of the first user includes registering the third party at the financial institution.

In Example 5, the subject matter of Examples 3-4 includes, wherein the authentication confirmation check requests at least one of typing a one-time confirmation code sent to the contact information of the third party on the second computing device of the first user, replying to a message sent to the contact information of the third party requesting to confirm authentication of the first user, clicking on a link included in a message sent to the contact information of the third party to confirm authentication of the first user, or pressing a key as requested in a call to the contact information of the third party to confirm authentication of the first user.

In Example 6, the subject matter of Examples 1-5 includes, registering a third computing device of a third party to the first user account; receiving an authorization request to complete a third financial transaction on the first user account, the third financial transaction having a third authentication level requirement; sending to the first computing device of the second user a third authentication request for the first user; receiving, using the processing circuitry, a third authentication confirmation by the second user at the application via the second user account; determining that the third authentication confirmation does not meet the third authentication level requirement of the third financial transaction; in response to the determination, sending a fourth authentication request to the third computing device; receiving a fourth authentication confirmation, the fourth authentication confirmation including information indicative of at least one of a tapped credit card on the third computing device of the third party, an entered confirmation code on the third computing device of the third party, or a confirmed authentication on an application on the third computing device of the third party; determining that the fourth authentication confirmation meets the third authentication level requirement of the third financial transaction; and in response to the determination, authorizing the third financial transaction on the first user account.

In Example 7, the subject matter of Example 6 includes, wherein the entered confirmation code includes at least one of a PIN, a swipe gesture, or a biometric recognition parameter.

Example 8 is at least one non-transitory machine-readable medium comprising instructions, which when executed by processing circuitry, cause the processing circuitry to perform operations to: link, using processing circuitry, a first user account of a first user to a second user account of a second user at a financial institution, the linking authorizing the first user to be authenticated by a first computing device of the second user; receive an authorization request to complete a first financial transaction on the first user account, the first financial transaction having an authentication level requirement; send to the first computing device of the second user an authentication request for the first user, the authentication request including a push notification to an application used to access the second user account on the first computing device of the second user; receive, using the processing circuitry, a first authentication confirmation from the second user at the application via the second user account; determine that the first authentication confirmation meets the authentication level requirement of the first financial transaction; and in response to the determination, authorize the first financial transaction on the first user account.

In Example 9, the subject matter of Example 8 includes, wherein to link the first user account to the second user account includes at least one of an addition of the second user account to a first profile of the first user or an addition of the first user account to a second profile of the second user.

In Example 10, the subject matter of Examples 8-9 includes, wherein the instructions further cause the processing circuitry to perform operations to: add a contact information of a third party to a first profile of the first user; receive a second authorization request to complete a second financial transaction on the first user account, the second financial transaction having a second authentication level requirement; send to a second computing device of the first user a second authentication request for the first user; in response to an indication received from the first user, send an authentication confirmation check to the contact information of the third party; receive, using the processing circuitry, a second authentication confirmation; determine that the second authentication confirmation meets the second authentication level requirement of the second financial transaction; and in response to the determination, authorize the second financial transaction on the first user account.

In Example 11, the subject matter of Example 10 includes, wherein to add the contact information of the third party to the first profile of the first user, the operations include to register the third party at the financial institution.

In Example 12, the subject matter of Examples 10-11 includes, wherein the authentication confirmation check requests at least one of a one-time confirmation code sent to the contact information of the third party typed to the second computing device of the first user, a reply to a message sent to the contact information of the third party requesting to confirm authentication of the first user, a click on a link included in a message sent to the contact information of the third party to confirm authentication of the first user, or a press of a key as requested in a call to the contact information of the third party to confirm authentication of the first user.

In Example 13, the subject matter of Examples 8-12 includes, wherein the instructions further cause the processing circuitry to perform operations to: register a third computing device of a third party to the first user account; receive an authorization request to complete a third financial transaction on the first user account, the third financial transaction having a third authentication level requirement; send to the first computing device of the second user a third authentication request for the first user; receive, using the processing circuitry, a third authentication confirmation by the second user at the application via the second user account; determine that the third authentication confirmation does not meet the third authentication level requirement of the third financial transaction; in response to the determination, send a fourth authentication request to the third computing device; receive a fourth authentication confirmation, the fourth authentication confirmation including information indicative of at least one of a tapped credit card on the third computing device of the third party, an entered confirmation code on the third computing device of the third party, or a confirmed authentication on an application on the third computing device of the third party; determine that the fourth authentication confirmation meets the third authentication level requirement of the third financial transaction; and in response to the determination, authorize the third financial transaction on the first user account.

In Example 14, the subject matter of Example 13 includes, wherein the entered confirmation code includes at least one of a PIN, a swipe gesture, or a biometric recognition parameter.

Example 15 is a system comprising: at least one processor; and memory including instructions, which when executed by the at least one processor, configure the at least one processor to perform operations comprising: linking, using processing circuitry, a first user account of a first user to a second user account of a second user at a financial institution, the linking authorizing the first user to be authenticated by a first computing device of the second user; receiving an authorization request to complete a first financial transaction on the first user account, the first financial transaction having an authentication level requirement; sending to the first computing device of the second user an authentication request for the first user, the authentication request including a push notification to an application used to access the second user account on the first computing device of the second user; receiving, using the processing circuitry, a first authentication confirmation from the second user at the application via the second user account; determining that the first authentication confirmation meets the authentication level requirement of the first financial transaction; and in response to the determination, authorizing the first financial transaction on the first user account.

In Example 16, the subject matter of Example 15 includes, wherein linking the first user account to the second user account includes at least one of adding the second user account to a first profile of the first user, or adding the first user account to a second profile of the second user.

In Example 17, the subject matter of Examples 15-16 includes, wherein the operations further include: adding a contact information of a third party to a first profile of the first user; receiving a second authorization request to complete a second financial transaction on the first user account, the second financial transaction having a second authentication level requirement; sending to a second computing device of the first user a second authentication request for the first user; in response to receiving an indication from the first user, sending an authentication confirmation check to the contact information of the third party; receiving, using the processing circuitry, a second authentication confirmation; determining that the second authentication confirmation meets the second authentication level requirement of the second financial transaction; and in response to the determination, authorizing the second financial transaction on the first user account.

In Example 18, the subject matter of Example 17 includes, wherein adding the contact information of the third party to the first profile of the first user includes registering the third party at the financial institution.

In Example 19, the subject matter of Examples 17-18 includes, wherein the authentication confirmation check requests at least one of typing a one-time confirmation code sent to the contact information of the third party on the second computing device of the first user, replying to a message sent to the contact information of the third party requesting to confirm authentication of the first user, clicking on a link included in a message sent to the contact information of the third party to confirm authentication of the first user, or pressing a key as requested in a call to the contact information of the third party to confirm authentication of the first user.

In Example 20, the subject matter of Examples 15-19 includes, wherein the operations further include: registering a third computing device of a third party to the first user account; receiving an authorization request to complete a third financial transaction on the first user account, the third financial transaction having a third authentication level requirement; sending to the first computing device of the second user a third authentication request for the first user; receiving, using the processing circuitry, a third authentication confirmation by the second user at the application via the second user account; determining that the third authentication confirmation does not meet the third authentication level requirement of the third financial transaction; in response to the determination, sending a fourth authentication request to the third computing device; receiving a fourth authentication confirmation, the fourth authentication confirmation including information indicative of at least one of a tapped credit card on the third computing device of the third party, an entered confirmation code on the third computing device of the third party, or a confirmed authentication on an application on the third computing device of the third party; determining that the fourth authentication confirmation meets the third authentication level requirement of the third financial transaction; and in response to the determination, authorizing the third financial transaction on the first user account.

Example 21 is a method for user authentication, the method comprising: receiving a selection to execute a first financial transaction on a first user account of a first user at a financial institution, the first financial transaction having an authentication level requirement; sending to a first computing device of the first user a selectable menu of authentication options via at least one third-party entity; receiving a selected authentication option of the authentication options via the selectable menu at the first computing device; determining that the first user completed the selected authentication option; determining that completing the selected authentication option satisfies the authentication level requirement for the first financial transaction; and in response to the determination, authorizing the first financial transaction to execute using the first user account.

In Example 22, the subject matter of Example 21 includes, wherein the selected authentication option includes a user login to an account of the first user at a third-party entity and wherein determining that the first user completed the selected authentication option includes receiving an authentication confirmation from the third-party entity.

In Example 23, the subject matter of Examples 21-22 includes, wherein the selected authentication option at a third-party entity includes completing a second financial transaction at the third-party entity, the third-party entity including at least one of a second financial institution, a digital payment network, or a digital wallet.

In Example 24, the subject matter of Examples 21-23 includes, in response to receiving the selected authentication option, sending a second authentication request to a third-party entity, the selected authentication option including at least one of a transaction at a third-party entity by the first user, a verification at the third-party entity of an identity of the first user, a validation using a debit card of the first user at the third-party entity or a validation using a credit card of the first user at the third-party entity, the debit card and the credit card associated to the financial institution; and wherein determining that the first user completed the selected authentication option includes receiving an authentication confirmation from the third-party entity.

In Example 25, the subject matter of Example 24 includes, wherein the third-party entity includes at least one of a physical store, an online store, a residential facility, or a care facility.

In Example 26, the subject matter of Examples 21-25 includes, wherein the selected authentication option at a third-party entity includes a transfer from an account of the first user at the third-party entity to an account specified by the financial institution.

In Example 27, the subject matter of Examples 21-26 includes, wherein the selected authentication option at a third-party entity includes a transfer from an account of the first user at the third-party entity to an account registered on the first user account at the financial institution.

Example 28 is at least one non-transitory machine-readable medium comprising instructions, which when executed by processing circuitry, cause the processing circuitry to perform operations to: receive a selection to execute a first financial transaction on a first user account of a first user at a financial institution, the first financial transaction having an authentication level requirement; send to a first computing device of the first user a selectable menu of authentication options via at least one third-party entity; receive a selected authentication option of the authentication options via the selectable menu at the first computing device; determine that the first user completed the selected authentication option; determine that completing the selected authentication option satisfies the authentication level requirement for the first financial transaction; and in response to the determination, authorize the first financial transaction to execute using the first user account.

In Example 29, the subject matter of Example 28 includes, wherein the selected authentication option includes a user login to an account of the first user at a third-party entity and wherein determining that the first user completed the selected authentication option includes receiving an authentication confirmation from the third-party entity.

In Example 30, the subject matter of Examples 28-29 includes, wherein the selected authentication option at a third-party entity includes a second financial transaction completed at the third-party entity, the third-party entity including at least one of a second financial institution, a digital payment network, or a digital wallet.

In Example 31, the subject matter of Examples 28-30 includes, wherein the instructions further cause the processing circuitry to perform operations to: in response to the receipt of the selected authentication option, send a second authentication request to a third-party entity, the selected authentication option including at least one of a transaction at a third-party entity by the first user, a verification at the third-party entity of an identity of the first user, a validation using a debit card of the first user at the third-party entity, or a validation using a credit card of the first user at the third-party entity, the debit card and the credit card associated to the financial institution; and wherein to determine that the first user completed the selected authentication option includes to receive an authentication confirmation from the third-party entity.

In Example 32, the subject matter of Example 31 includes, wherein the third-party entity includes at least one of a physical store, an online store, a residential facility, or a care facility.

In Example 33, the subject matter of Examples 28-32 includes, wherein the selected authentication option at a third-party entity includes a transfer from an account of the first user at the third-party entity to an account specified by the financial institution.

In Example 34, the subject matter of Examples 28-33 includes, wherein the selected authentication option at a third-party entity includes a transfer from an account of the first user at the third-party entity to an account registered on the first user account at the financial institution.

Example 35 is a system comprising: at least one processor; and a storage device comprising instructions, which when executed by the at least one processor, configure the at least one processor to perform operations comprising: receiving a selection to execute a first financial transaction on a first user account of a first user at a financial institution, the first financial transaction having an authentication level requirement; sending to a first computing device of the first user a selectable menu of authentication options via at least one third-party entity; receiving a selected authentication option of the authentication options via the selectable menu at the first computing device; determining that the first user completed the selected authentication option; determining that completing the selected authentication option satisfies the authentication level requirement for the first financial transaction; and in response to the determination, authorizing the first financial transaction to execute using the first user account.

In Example 36, the subject matter of Example 35 includes, wherein the selected authentication option includes a user login to an account of the first user at a third-party entity and wherein determining that the first user completed the selected authentication option includes receiving an authentication confirmation from the third-party entity.

In Example 37, the subject matter of Examples 35-36 includes, wherein the selected authentication option at a third-party entity includes completing a second financial transaction at the third-party entity, the third-party entity including at least one of a second financial institution, a digital payment network, or a digital wallet.

In Example 38, the subject matter of Examples 35-37 includes, in response to receiving the selected authentication option, sending a second authentication request to a third-party entity, the selected authentication option including at least one of a transaction at a third-party entity by the first user, a verification at the third-party entity of an identity of the first user, a validation using a debit card of the first user at the third-party entity or a validation using a credit card of the first user at the third-party entity, the debit card and the credit card associated to the financial institution; and wherein determining that the first user completed the selected authentication option includes receiving an authentication confirmation from the third-party entity.

In Example 39, the subject matter of Example 38 includes, wherein the third-party entity includes at least one of a physical store, an online store, a residential facility, or a care facility.

In Example 40, the subject matter of Examples 35-39 includes, wherein the selected authentication option at a third-party entity includes a transfer from an account of the first user at the third-party entity to at least one of an account specified by the financial institution or an account registered on the first user account at the financial institution.

Example 41 is at least one machine-readable medium including instructions that, when executed by processing circuitry, cause the processing circuitry to perform operations to implement of any of Examples 1-40.

Example 42 is an apparatus comprising means to implement of any of Examples 1-40.

Example 43 is a system to implement of any of Examples 1-40.

Example 44 is a method to implement of any of Examples 1-40.

Method examples described herein may be machine or computer-implemented, at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for user authentication, the method comprising:
receiving a selection to execute a first financial transaction on a first user account of a first user at a financial institution, the first financial transaction having an authentication level requirement;
sending to a first computing device of the first user a selectable menu of authentication options via at least one third-party entity;
receiving a selected authentication option of the authentication options via the selectable menu at the first computing device;
determining that the first user completed the selected authentication option;
determining that completing the selected authentication option satisfies the authentication level requirement for the first financial transaction; and
in response to the determination, authorizing the first financial transaction to execute using the first user account.

2. The method of claim 1, wherein the selected authentication option includes a user login to an account of the first user at a third-party entity and wherein determining that the first user completed the selected authentication option includes receiving an authentication confirmation from the third-party entity.

3. The method of claim 1, wherein the selected authentication option at a third-party entity includes completing a second financial transaction at the third-party entity, the third-party entity including at least one of a second financial institution, a digital payment network, or a digital wallet.

4. The method of claim 1, further comprising:
in response to receiving the selected authentication option, sending a second authentication request to a third-party entity, the selected authentication option including at least one of a transaction at a third-party entity by the first user, a verification at the third-party entity of an identity of the first user, a validation using a debit card of the first user at the third-party entity or a validation using a credit card of the first user at the third-party entity, the debit card and the credit card associated to the financial institution; and
wherein determining that the first user completed the selected authentication option includes receiving an authentication confirmation from the third-party entity.

5. The method of claim 4, wherein the third-party entity includes at least one of a physical store, an online store, a residential facility, or a care facility.

6. The method of claim 1, wherein the selected authentication option at a third-party entity includes a transfer from an account of the first user at the third-party entity to an account specified by the financial institution.

7. The method of claim 1, wherein the selected authentication option at a third-party entity includes a transfer from an account of the first user at the third-party entity to an account registered on the first user account at the financial institution.

8. At least one non-transitory machine-readable medium comprising instructions, which when executed by processing circuitry, cause the processing circuitry to perform operations to:
receive a selection to execute a first financial transaction on a first user account of a first user at a financial institution, the first financial transaction having an authentication level requirement;
send to a first computing device of the first user a selectable menu of authentication options via at least one third-party entity;
receive a selected authentication option of the authentication options via the selectable menu at the first computing device;
determine that the first user completed the selected authentication option;
determine that completing the selected authentication option satisfies the authentication level requirement for the first financial transaction; and
in response to the determination, authorize the first financial transaction to execute using the first user account.

9. The at least one non-transitory machine-readable medium of claim 8, wherein the selected authentication option includes a user login to an account of the first user at a third-party entity and wherein determining that the first user completed the selected authentication option includes receiving an authentication confirmation from the third-party entity.

10. The at least one non-transitory machine-readable medium of claim 8, wherein the selected authentication option at a third-party entity includes a second financial transaction completed at the third-party entity, the third-party entity including at least one of a second financial institution, a digital payment network, or a digital wallet.

11. The at least one non-transitory machine-readable medium of claim 8, wherein the instructions further cause the processing circuitry to perform operations to:
in response to the receipt of the selected authentication option, send a second authentication request to a third-party entity, the selected authentication option including at least one of a transaction at a third-party entity by the first user, a verification at the third-party entity of an identity of the first user, a validation using a debit card of the first user at the third-party entity, or a validation using a credit card of the first user at the third-party entity, the debit card and the credit card associated to the financial institution; and
wherein to determine that the first user completed the selected authentication option includes to receive an authentication confirmation from the third-party entity.

12. The at least one non-transitory machine-readable medium of claim 11, wherein the third-party entity includes at least one of a physical store, an online store, a residential facility, or a care facility.

13. The at least one non-transitory machine-readable medium of claim 8, wherein the selected authentication option at a third-party entity includes a transfer from an account of the first user at the third-party entity to an account specified by the financial institution.

14. The at least one non-transitory machine-readable medium of claim 8, wherein the selected authentication option at a third-party entity includes a transfer from an account of the first user at the third-party entity to an account registered on the first user account at the financial institution.

15. A system comprising:
at least one processor; and
a storage device comprising instructions, which when executed by the at least one processor, configure the at least one processor to perform operations comprising:
receiving a selection to execute a first financial transaction on a first user account of a first user at a financial institution, the first financial transaction having an authentication level requirement;
sending to a first computing device of the first user a selectable menu of authentication options via at least one third-party entity;
receiving a selected authentication option of the authentication options via the selectable menu at the first computing device;
determining that the first user completed the selected authentication option;
determining that completing the selected authentication option satisfies the authentication level requirement for the first financial transaction; and
in response to the determination, authorizing the first financial transaction to execute using the first user account.

16. The system of claim 15, wherein the selected authentication option includes a user login to an account of the first user at a third-party entity and wherein determining that the first user completed the selected authentication option includes receiving an authentication confirmation from the third-party entity.

17. The system of claim 15, wherein the selected authentication option at a third-party entity includes completing a second financial transaction at the third-party entity, the third-party entity including at least one of a second financial institution, a digital payment network, or a digital wallet.

18. The system of claim 15, further comprising:
in response to receiving the selected authentication option, sending a second authentication request to a third-party entity, the selected authentication option including at least one of a transaction at a third-party entity by the first user, a verification at the third-party entity of an identity of the first user, a validation using a debit card of the first user at the third-party entity or a validation using a credit card of the first user at the third-party entity, the debit card and the credit card associated to the financial institution; and
wherein determining that the first user completed the selected authentication option includes receiving an authentication confirmation from the third-party entity.

19. The system of claim 18, wherein the third-party entity includes at least one of a physical store, an online store, a residential facility, or a care facility.

20. The system of claim 15, wherein the selected authentication option at a third-party entity includes a transfer from an account of the first user at the third-party entity to at least one of an account specified by the financial institution or an account registered on the first user account at the financial institution.
